(19) United States
(12) Patent Application Publication
(10) Pub. No.: US 2008/0004144 A1
(43) Pub. Date: Jan. 3, 2008

(54) ROLLER DRIVE END AND METHOD FOR MOUNTING A DRIVE UNIT TO A DRIVE JOURNAL

(76) Inventor: Herbert Bosch, Gerstetten (DE)

Correspondence Address: TAYLOR & AUST, P.C., P.O. Box 560, 142. S Main Street, Avilla, IN, 46710, US

(21) Appl. No.: 11/763,614

(22) Filed: Jun. 15, 2007

(30) Foreign Application Priority Data
Jul. 1, 2006 (DE) 10 2006 030 502.7

(51) Int. Cl. F16C 13/00; D21G 1/02

(52) U.S. Cl. 474/166; 29/700

(57) ABSTRACT

A drive end system associated with a roller for producing and/or treating a material web, in particular a paper web or paperboard web, includes a roller casing and a drive journal which is connected to the roller casing in order to drive said casing. The drive journal stands in a driven connection to a drive unit or can be switched into such a driven connection. The drive end system also includes a drive flange which is provided for the non-rotatable connection of the drive journal and the drive unit. The drive flange is press-fitted and/or shrink-fitted onto the drive journal such that a drive-power-transmitting, friction-locked connection is formed between the joint faces of the drive flange and the joint faces of the drive journal by way of an interference fit.

### BACKGROUND OF THE INVENTION

1. Field of the Invention

This invention relates in general to the drive of a roller for producing and/or treating a material web, in particular a paper web or paperboard web. In detail this invention relates to the design of a drive end of such a roller and to a method for mounting a drive unit to a drive journal of such a roller.

2. Description of the Related Art

The roller drive of the type to which this invention relates, for example the drive of the drying cylinder of a paper machine, is traditionally effected on the driven end of the drying section by way of a drive journal which is coupled by way of a featherkey to an articulated shaft or a solid steel coupling. The drive journal can be driven in this case by way of an individual drive or by way of a power take-off gear which divides the drive power of one drive unit among several rollers. For example, the drive journal is mounted on the driven end in a wheel case and connected by way of featherkey connections to the gearwheels of the gear unit.

In particular when connecting an individual drive—meaning when each roller is driven by way of an own drive unit—connecting the drive regularly requires that a drive flange be connected to the drive journal, by way of which flange the drive torque or drive power is transmitted from the drive unit to the drive journal in order to rotate the roller in the required direction. The drive flange is bolted in this case with a multiplicity of bolts onto the outer end face of the drive journal in order to be able to transmit the required high torque from the drive flange to the drive journal by way of the corresponding number of bolts.

In practice it has turned out to be a disadvantage that, particularly when converting existing roller drives to individual drives of the type to which this invention relates and which are arranged in particular on the so-called operator end of the paper machine, considerable refinishing work is required locally for the subsequent drilling of essential threaded bores for the axial threaded connection, and that frequently the small wall thickness of the drive journal makes it impossible or difficult to add corresponding bores with a large diameter.

What is needed in the art is a roller drive end with a drive flange connected to the drive journal, with which drive flange the previously mentioned problems are avoided and in particular a secure connection is obtained between the drive flange and the drive journal, wherein on the one hand said connection can be mounted with little effort locally and largely dispenses with the refinishing work required locally, and on the other hand enables the transmission of a sufficiently high torque. Also disclosed is a method with which a drive unit can be mounted on and in particular retrofitted to a drive journal of a corresponding roller, in particular to a drying cylinder of a paper machine, in order to drive the roller or the drying cylinder in particular by way of an individual drive on the operator end or the driven end.

### SUMMARY OF THE INVENTION

The inventive roller drive end is particularly suitable for driving the roller by way of a drive unit on the operator end. Of course it is also possible, however, for the drive end of the roller on the driven end to be configured accordingly and for the roller to be driven by way of a corresponding drive unit on the driven end. The driven end is understood in this case to be the end of the axial end of the rollers at which the rollers were traditionally driven by drive units, said axial end being mounted by way of an axial radial bearing. The operator end is understood to be the opposite axial end of the roller, which end is accessible to the machine operator during operation of the roller and on which the roller is movably mounted by way of a radial bearing.

The roller can be driven in particular by way of an individual drive, meaning that given a multiplicity of rollers arranged side by side or one above the other each roller is driven by its own drive unit, wherein the drive unit is mounted, for example mounted overhung, in particular on the drive journal or the drive flange.

The inventive drive end of a roller for producing and/or treating a material web, in particular a paper web or paperboard web, has a roller casing and a drive journal. The drive journal is connected to the roller casing in order to drive said casing. Generally, the roller can also be a solid roller, but it is usually a hollow roller, meaning that it has a hollow-cylinder-shaped roller casing. The roller is, for example, the drying cylinder of a paper machine.

The drive journal stands in a driven connection to a drive unit or at least it can be switched into such a driven connection.

The inventive drive end has in addition a drive flange in order to connect the drive unit non-rotatably to the drive journal.

In this case the drive flange is press-fitted and/or shrink-fitted onto the drive journal such that a drive-power-transmitting, friction-locked connection is formed between the joint faces of the drive flange and the joint faces of the drive journal by way of an interference fit. The shrink-fitting can take place solely by heating the drive flange. Alternatively or in addition to this, the drive journal can be cooled simultaneously. Those skilled in the art are familiar with suitable measures for performing the shrink-fitting.

The inventive drive end of a corresponding roller makes it possible for the drive unit to be attached directly to the roller drive end, for example by direct bolting of the drive unit to the drive flange. According to a special version of the invention it is also possible for an intermediate flange to be mounted first onto the drive flange and then for the drive unit to be mounted onto said intermediate flange, wherein both mountings can be effected respectively by a threaded connection.

It is particularly advantageous for the drive unit to be mounted overhung on the drive journal by way of the drive flange and in particular by way of the additionally provided intermediate flange. To secure the stator of the drive unit against twisting, said stator can be braced by a torque arm for example. Otherwise, the drive unit can be free of any other bracing or bearing point, meaning that it is indirectly supported solely by the drive journal and braced by the torque arm.

Either the drive flange is connected to the drive journal, in addition to the interference fit, by way of a form-locked and/or friction-locked connection, for example by way of a plug-in connection and/or a threaded connection. Or, in the interest of a particularly quick mounting, the drive flange is connected to the drive journal solely by way of the interference fit, which is effected by shrink-fitting and/or press-fitting the drive flange onto the drive journal.

It is particularly advantageous for the drive flange to extend over an axial section of the drive journal such that said drive flange is arranged between a bearing, which supports the drive journal, and the drive journal itself. The bearing can be a rolling bearing for example, which is advantageously constructed as a so-called toroidal roller bearing. Such a toroidal roller bearing has barrel-shaped, convex rollers as rolling elements, which enable any alignment errors and axial offsets of the drive journal to be compensated. Such toroidal roller bearings are available under the protected name CARB from the company SKF for example. Also possible of course are other bearings such as tapered-roller bearings or self-aligning roller bearings.

For example, the entire roller can be carried by the previously described drive journal and usually a second journal, which is provided on the opposite axial end of the roller and mounted likewise in a bearing, for example a rolling bearing. If the inventive roller drive end is arranged on the operator end of the roller and this end is subject to axial displacement due to thermal expansion, then the bearing is constructed as an axial floating bearing.

The drive unit can be constructed in the form of an electric motor for example, wherein such a construction is particularly well suited for the overhung mounting. Needless to say, other drive concepts are also possible.

When the drive flange extends from the axially outer end of the drive journal into the bearing in which the journal is mounted, then the drive flange adjoins advantageously flush or essentially flush with the bearing on the axially inner side of the bearing. Furthermore, the drive flange encloses the drive journal advantageously in full or essentially in full at least in the region of the bearing or overall in the circumferential direction.

An advantage of the inventive method for mounting a drive unit on a drive journal, in particular in order to produce an inventive roller drive end as described, is that there is no need for the existing journal to be refinished, locally if necessary, before the drive flange is press-fitted and/or shrink-fitted in order to obtain the drive-power-transmitting connection between the joint faces of the drive journal and the drive flange by way of an interference fit. Hence the drive unit needs only to be connected, with or without an intermediate flange, in a drive connection to the drive flange.

The journal can be conically tapered in the direction of its axially outer end for example, whereas the drive flange can have a cylindrical outer circumference. Of course it is also possible to construct the drive flange with a likewise conical outer circumference tapered in particular in the direction of the axial end of the roller or to provide the drive journal with an outer circumference tapered in the opposite axial direction or with a cylindrical shape.

When the drive flange is press-fitted and/or shrink-fitted onto the drive journal, then a bearing can be pulled from outside onto the drive flange in order to support the drive journal indirectly by way of the drive flange. The bearing with its housing can then be mounted in a fixed position in a support for example. In particular when an existing roller journal is retrofitted in accordance with the invention with a drive flange and a corresponding drive unit, then an existing bearing can be replaced by a larger bearing with a larger inner diameter.

In particular an existing drive unit, situated on the driven end or the operator end and simultaneously driving a multiplicity of rollers for example, can be either supplemented or replaced by the inventive mounting of another drive unit, wherein a multiplicity of inventively mounted drive units can be provided for a planned individual drive.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawing, wherein:

FIG. 1 is a sectional view of a drive end of a roller according to the present invention.

Corresponding reference characters indicate corresponding parts throughout the several views. The exemplification set out herein illustrates embodiment of the invention, and such exemplification is not to be construed as limiting the scope of the invention in any manner.

### DETAILED DESCRIPTION OF THE INVENTION

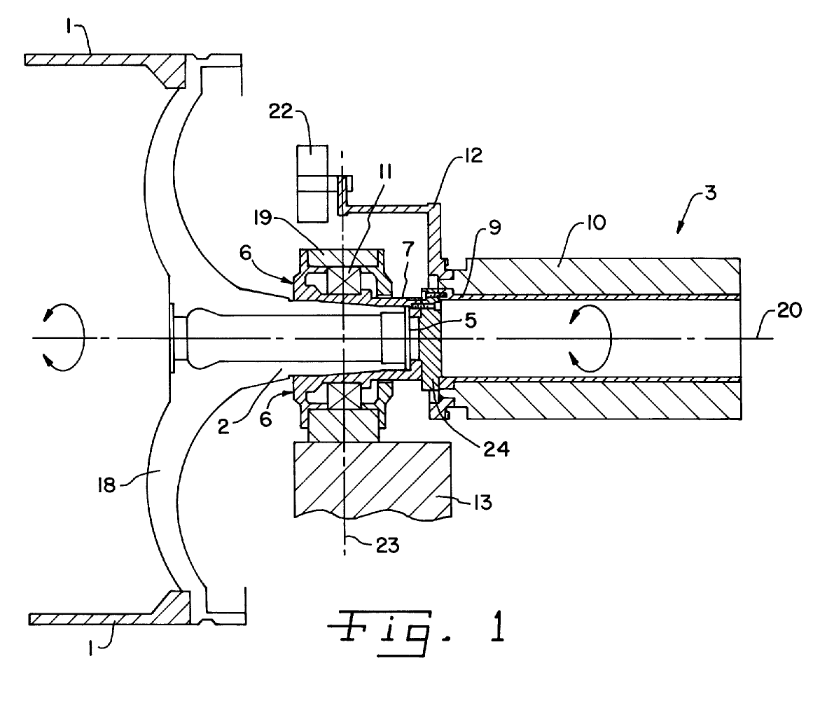

Referring now to the drawing, FIG. 1, there is shown a hollow-cylinder-shaped roller casing 1 of a drying cylinder, said casing being closed by a cylinder cap 18 which leads into a drive journal 2. The drive journal 2 is mounted in a bearing 11 in the form of a rolling bearing. The bearing 11 has a multiplicity of rolling elements which are enclosed by a bearing housing 19. The bearing housing 19 is mounted in turn on a foundation or support 13.

In this case the drive journal 2 is mounted in the bearing 11 indirectly by way of a drive flange 7. The drive flange 7 is thus enclosed like a sandwich or at both ends between the drive journal 2 and the inner ring of the bearing 11. The drive flange 7 encloses the drive journal 2 fully over the entire circumference of the drive journal 2, from the axially inner end 6 of the bearing 11 or bearing housing 19 to the axially outer end face 5 of the drive journal 2.

According to experience the drive flange 7 is press-fitted and/or shrink-fitted onto the drive journal 2, which in this case is tapered in steps in the direction of its axially outer end 5, wherein provision can also be made alternatively for a continuous taper, a corresponding expansion or a constant diameter. In this case the drive flange 7 extends somewhat beyond the axially outer end face 5 of the drive journal 2.

Mounted on the end face of the drive flange 7, namely in the region of the axially outer end face 5 of the drive journal 2, is an intermediate flange 24. In this case the intermediate flange is bolted to the end face of the drive flange 7.

Mounted on the intermediate flange 24 is the rotor 9 of the drive unit 3, said rotor being enclosed by the stator 10 in circumferential direction. In the case in question the rotor 9 is bolted likewise to the end face of the intermediate flange 24 so that, looking in the axial direction, the intermediate flange 24 is enclosed on both sides, once by the drive flange 7 and once by the rotor 9.

The stator 10 is supported in a preselected fixed point 22 by way of a torque arm 12 on the support 13. In this case the supporting forces can be dissipated into the support in the plane 23 of the axial center of the bearing 11. Of course, the dissipation of supporting forces into the support 13 can also be axially offset from the plane 23.

On the embodiment presented, the roller casing 1, the drive journal 2, the components of the bearing 11, the intermediate flange 24, the rotor 9 and the stator 10 are arranged concentrically and axially flush with each other over the axial longitudinal axis 20. This results in the smallest possible unbalance during rotation of the roller.

Although this is not illustrated, the rotor 9 can also be mounted directly on the drive flange 7, thus dispensing with the intermediate flange 24. Alternatively it is possible to provide more elements between the drive flange 7 and the drive unit 3 as long as a drive connection is established between the driving part of the drive unit 3 (the rotor 9) and the drive journal 2.

According to another embodiment (not illustrated), the rotor 9 of the drive unit 3 is constructed in a single piece or integrally with the drive flange 7 so that the rotor 9 can be press-fitted and/or shrink-fitted onto the drive journal 2 in particular without an additional threaded connection being necessary.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A drive end system associated with a roller for at least one of producing and treating a fibrous material web, said drive end system comprising:
a roller casing;
a drive journal connected to said roller casing for driving said roller casing, said drive journal including a plurality of joint faces;
a drive unit being one of in a driven connection and configured for being switched into said driven connection to said drive journal; and
a drive flange forming a non-rotatable connection of said drive journal and said drive unit, said drive flange including a plurality of joint faces, said drive flange forming at least one of a press-fit and a shrink-fit onto said drive journal such that a drive-power-transmitting, friction-locked connection is formed between said plurality of joint faces of said drive flange and said plurality of joint faces of said drive journal with an interference fit.

2. The drive end system according to claim 1, wherein said drive unit is mounted overhung on said drive journal using said drive flange.

3. The drive end system according to claim 2, further comprising a torque arm, said drive unit being free of at least one of any other bracing points and any other bearing points except for said torque arm, said drive unit being braced against twisting using said torque arm.

4. The drive end system according to claim 3, wherein said drive unit includes a stator.

5. The drive end system according to claim 1, wherein said drive flange is connected to said drive journal solely with said interference fit.

6. The drive end system according to claim 1, further comprising an intermediate flange, said drive journal including an axially outer end face, said intermediate flange being mounted on said drive flange at least near said axially outer end face of said drive journal, said drive unit being connected to said intermediate flange.

7. The drive end system according to claim 6, wherein said drive flange includes an end face, said intermediate flange being bolted on said end face of said drive flange.

8. The drive end system according to claim 6, wherein said drive unit includes a rotor.

9. The drive end system according to claim 6, wherein said intermediate flange includes an end face, said drive unit being bolted on said end face of said intermediate flange.

10. The drive end system according to claim 6, further comprising a bearing, said drive journal being rotatably mounted in said bearing, said drive flange enclosing said drive journal starting from said axially outer end face of said drive journal in a direction of said bearing and radially within said bearing in a circumferential direction such that said drive journal is mounted indirectly in said bearing using said drive flange.

11. The drive end system according to claim 10, wherein said bearing is one of a tapered-roller bearing, a self-aligning roller bearing, and a toroidal roller bearing.

12. The drive end system according to claim 10, wherein said bearing includes an axially inner side, said drive flange adjoining one of flush and essentially flush with said bearing on said axially inner side of said bearing.

13. A method for mounting a drive unit on a drive journal of a roller for at least one of producing and treating a fibrous material web, said method comprising the steps of:
at least one of press-fitting and shrink-fitting a drive flange onto the drive journal such that a drive-power-transmitting, friction-locked connection is formed between a plurality of joint faces of the drive journal and a plurality of joint faces of said drive flange with an interference fit; and
connecting the drive unit to said drive flange in a drive connection.

14. The method according to claim 13, wherein the drive unit with its rotor is mounted at least one of friction-locked and form-locked on one of said drive flange and an intermediate flange connected to an end face of said drive flange.

15. The method according to claim 14, wherein said intermediate flange is bolted on said end face of said drive flange.

16. The method according to claim 14, wherein the drive unit with its rotor is bolted to an end face of said intermediate flange.

17. The method according to claim 14, further comprising the step of one of supplementing and replacing an existing drive unit by mounting one of the drive unit and a plurality of the drive units.

18. The method according to claim 17, wherein said existing drive unit simultaneously drives a plurality of rollers.

19. The method according to claim 13, wherein the drive unit is mounted overhung on the drive journal using said drive flange.

20. The method according to claim 13, further comprising the steps of:
pulling a bearing onto said drive flange; and
mounting said bearing in a fixed position.

21. The method according to claim 20, wherein said steps of pulling and mounting are after at least one of said press fitting and said shrink-fitting said drive flange onto the drive journal.

22. The method according to claim 21, wherein said step of mounting includes using a support.
